(19) United States
(12) Patent Application Publication
(10) Pub. No.: US 2020/0282247 A1
(43) Pub. Date: Sep. 10, 2020

(54) SPRINKLER DEVICE, CONNECTING PIECE, SPRINKLER SYSTEM AND A METHOD FOR PRODUCING AND USING SAME

(71) Applicant: Miktat Batagan, Aldingen (DE)

(72) Inventor: Miktat Batagan, Aldingen (DE)

(21) Appl. No.: 16/644,696

(22) PCT Filed: Oct. 6, 2017
(86) PCT No.: PCT/EP2017/075499

§ 371 Date: Mar. 5, 2020

(30) Foreign Application Priority Data
Sep. 7, 2017 (DE) 102017120659.0

(51) Int. Cl. A62C 35/68; A62C 37/14; F16L 37/252

(52) U.S. Cl. CPC A62C 35/68; F16L 37/252; A62C 37/14

(57) ABSTRACT

A sprinkler device with a sprinkler head which comprises a pipe element and a frame element connected to the pipe element is proposed. The pipe element comprises at least two latching elements on its outer periphery, which extend radially outwards from the outer peripheral surface of the pipe element. In addition, the pipe element further has at least one groove extending in the peripheral direction on its outer surface, in which groove a sealing element can be received. When viewed in the axial direction of the pipe element in the direction towards the water inlet opening, the at least one groove is spaced further from the water outlet opening than the at least two latching elements. Furthermore, a connecting piece, a sprinkler system and a production method and a use thereof are proposed.

### FIELD OF THE INVENTION

The invention relates to a sprinkler device, a connecting piece, a sprinkler system and a method for producing and using same.

Sprinkler installations serve as automatic, stationary fire-extinguishing installations which are frequently used in special constructions such as skyscrapers, office buildings, department stores, production halls, warehouses, hospitals and underground car parks. In this case, they form part of the fire-protection system which is generally required by authorities or insurers. Conventional sprinkler installations are intended to detect the fire from the heat produced, be activated automatically and fight the fire, ideally while it is still developing.

As a safety-critical system, sprinkler installations are subject to specific guidelines in planning, fitting, operation and installation. In particular, in designing these installations, the specifications according to the property insurers association guideline VdS CEA 4001 and the standard DIN EN 12845 are to be respected. Requirements are placed on the water supply, the piping system and also on the type and reaction sensitivity of the sprinkler nozzles in dependence upon the respective usage location, i.e. the region where the sprinkler installation is fitted.

According to the class of fire risk of the usage location, there is a maximum area of coverage which can be reliably covered by an individual sprinkler nozzle. From this it is possible to derive maximum distances between the individual sprinkler nozzles depending on the sprinkler arrangement. Especially in large spaces, such as warehouses or production halls, this leads to a large number of sprinkler nozzles to be fitted.

Owing to the large number of sprinkler nozzles to be fitted, a considerable expenditure of time and personnel is required especially in airports, production sites etc. in order to fit the sprinkler nozzles or to check, and possibly replace, them during maintenance, whereby not inconsiderable costs are also incurred, in addition to the shear amount of time. Thus, in order to fit a sprinkler installation, e.g. in production halls, several hundred sprinkler nozzles must be used. Even with a large number of fitters employed on the fitting work at the same time, this can take a number of days to weeks and, in exceptional cases, even months.

In this case, these sprinkler nozzles are generally fitted by means of a screw-on thread formed on the sprinkler head, via which each sprinkler nozzle to be mounted is screwed into a corresponding counter-piece of the pipe system. This screwing-in must take place from an overhead position and requires, in particular in the case of manual turning of the sprinkler nozzles into the pipe, a sometimes considerable application of force by the fitter.

The work is thus physically strenuous for the fitter since not only is the overhead position unfavourable for him, in addition a certain force is required to turn the sprinkler nozzles into the pipe in order to be able to ensure a tight connection. This high level of strain often leads to damage to the shoulder or shoulder-neck region, especially the shoulder joint. In addition, there is a considerable risk of injury for the fitter when turning the sprinkler nozzles into the pipe, in particular on sharp edges and the deflector.

In most cases, in addition, it is possible to turn the sprinkler nozzles fully into the pipe manually only with the aid of open-end wrenches or pipe wrenches or the like since only in this way can a sufficiently high tightening torque be applied in order to fasten the sprinkler nozzles to the pipe in a water-tight manner.

Although tools of this type make work easier for the fitter, they are generally not primarily designed for mounting sprinklers. Although they facilitate the transmission of force to the sprinkler nozzle, they constitute an additional weight for the fitter to hold overhead.

Owing to the high application of force to the sprinkler nozzle there is also the risk of damaging them during mounting. High shear loading acts especially on the deflector e.g. if gripped by the fitter during the screwing-in process, this loading being able to lead to bending—or in the worst case even detachment—of the deflector. When using tools, it is also possible for damage, e.g. cracks in the glass bulb or breakage of individual screw threads of the sprinkler nozzle, to be caused and not detected. Such risks are to be avoided especially in safety-critical installations in order to be able to ensure correct function of the sprinkler installations.

Alternatively, there are mounting techniques in which the sprinkler nozzles are fastened to the pipe piece in advance by welding processes or pressing processes. However, in so doing, high temperatures are produced in the immediate proximity of the sprinkler nozzle and, if the fitter is inattentive, can rapidly lead to heating of same and therefore to bursting of the glass bulb. In addition, the problem of the high level of force to be applied is intensified during work to be carried out overhead since then, instead of the sprinkler nozzle, whole pipe pieces together with the sprinkler nozzle must be mounted on the piping systems.

### PRIOR ART

Sprinkler systems which include a sprinkler nozzle with a fluid line formed therein and a deflector are known from the prior art, see e.g. DE 199 07 442 A1 or WO 2007/124403 A2.

By means of the deflector, the liquid supplied via piping and flowing out of the sprinkler body can be dispersed over a large area, wherein, depending on the geometry of the sprinkler nozzle and deflector, a smaller or larger region can be covered, depending on the water pressure. In the systems known from the prior art, a section of the sprinkler body has a threaded section on its outer periphery. By means of this outer thread, the sprinkler nozzle is manually screwed to piping.

Furthermore, the prior art discloses auxiliary tools for assisting in the mounting of such sprinkler nozzles with a thread. Thus, e.g. EP 1 690 635 A2 discloses a device and method for mechanical mounting of sprinkler nozzles. In that case, a mounting device is formed which can engage around the sprinkler head of a sprinkler nozzle.

During mounting of the sprinkler nozzle on piping, in the system disclosed in EP 1 690 635 A2, the sprinkler nozzle is likewise screwed into an inner thread of a corresponding piping, wherein, in this case, the first turns of the thread must be screwed in manually. Then the mounting device specially designed for this sprinkler nozzle is placed in the correct position on the sprinkler head.

By means of this mounting device, the mechanical screwing-in finally takes place with the aid of a cordless screwdriver which can be applied to the mounting device. After screwing-in, the mounting device must then be removed from the sprinkler head in order to be placed over the next sprinkler head after the sprinkler nozzle has already been partially screwed in manually.

As presented above, the sprinkler nozzles must be screwed into the piping with considerable expenditure of force and in an overhead position. Although the screwing-in of the sprinkler nozzle is facilitated with this device, the fitter must still apply a lot of force since, on the one hand, he must screw in the first turns of the thread himself, and, on the other hand, he must lift the heavy mounting device. This troublesome fitting of the sprinkler nozzles causes the fitter to become tired quickly and therefore ultimately leads to errors in mounting.

Owing to the mandated large number of sprinkler nozzles to be fitted the installation of such sprinkler installations is also associated with a considerable expenditure of time. The fitting of sprinkler installations thus frequently creates problems for the building sector, since the prevailing pressures in terms of time and costs are particularly high in that sector. However, special tools fall short in their effect since they additionally increase the costs of the sprinkler installation and are an additional weight for the fitter which he must hold and operate overhead.

Proceeding from the prior art, the object of the invention is thus to create a sprinkler device which is inexpensive to produce, and which can be integrated easily, reliably and quickly even into already existing pipe systems and which is easy to maintain. In addition, it is the object of the invention to create a connecting piece which permits easy, reliable and quick fitting of the sprinkler device, can additionally be integrated easily, reliably and quickly on existing piping and is favourable to produce.

### SUMMARY OF THE INVENTION

This object is achieved by a sprinkler device, a connecting piece, a sprinkler system and a method for producing a sprinkler device and a method for producing a connecting piece as well as a use of a sprinkler device and of a connecting piece.

In accordance with the invention, the sprinkler device consists of a sprinkler head which comprises a pipe element and a frame element connected to the pipe element. The pipe element comprises a water inlet opening and a water outlet opening opposite the water inlet opening in the axial direction of the pipe element and facing the frame element, wherein a closure element is received in the water outlet opening and closes same. Between the closure element and the frame element, a liquid-filled glass bulb is disposed in the longitudinal direction of the sprinkler head in such a way that its first end lies against the closure element and its second end lies against the frame element, whereby the glass bulb holds the closure element in the water outlet opening of the pipe element. The sprinkler device is characterised in that the pipe element comprises at least two latch elements on its outer periphery, which latch elements extend radially outwards from the outer peripheral surface of the pipe element, and the pipe element, on its outer surface, further comprises at least one groove extending in the peripheral direction, in which a sealing element can be received, wherein, when viewed in the axial direction of the pipe element in the direction towards the water inlet opening, the at least one groove is spaced further apart from the water outlet opening than the at least two latching elements.

By means of the sprinkler device in accordance with the invention, it is possible to ensure the most rapid possible mounting of the sprinkler device. By means of the latching elements formed on the outer periphery of the pipe element, this is inserted into a corresponding pipe-side counter-piece and then turned.

Depending on the number of latching elements and the length of the receiver extending on the inner periphery in the peripheral direction, approximately a quarter turn, but in any case, a turn of less than 180 degrees, is required to turn the sprinkler device. Therefore, it is conceivably possible to mount the sprinkler device quickly in comparison with conventionally known sprinkler devices since the number of turns to be effected during mounting is reduced from a multiplicity of thread stages to less than a half turn.

The mounting time required for installation of sprinkler devices can be reduced to a fraction. In particular, in the case of a large number of sprinkler devices to be installed, by means of the sprinkler device in accordance with the invention, a time benefit can be achieved owing to the reduced mounting time, this time benefit is reflected in clearly lower mounting costs. For example, in the case of an equal number of sprinkler devices to be installed, clearly fewer fitters are necessary, or with the same number of fitters the mounting times for creating a sprinkler installation can be greatly reduced.

By the formation of an inventive plug-and-turn connection between a sprinkler device and piping system, mounting is additionally kept as simple as possible. For this purpose, the introduction of the latching elements is foolproof in that a plurality of combinations, i.e. a plurality of turning angles, between latching elements and apertures formed in the counter-piece are possible. This means that the sprinkler device can be inserted into the counter-piece in any desired position varied about its longitudinal axis. In other words, there is no incorrect introduction of the sprinkler device, wherein a specific latching element would be inserted into an incorrect aperture or depression—i.e. one not associated with it.

Thus, the frequency with which errors occur during mounting can be reduced not only by reason of the reduction in mounting time and therefore the workload on the individual fitter, but also by reason of the design of the sprinkler device to be mounting error-proof. This is desirable in the case of a safety-critical installation such as a sprinkler installation.

According to one development of the sprinkler device, the at least two latching elements can be disposed on a common plane perpendicular to the axial direction of the pipe element.

By means of this development, the complexity of producing the sprinkler device is reduced. Since the production process is simplified by reduced complexity, it is possible in this way to reduce production costs. Since the geometry of the corresponding pipe counter-piece is dictated by the design of the sprinkler device, in particular the design of the latching elements, a simplification can also be achieved in this respect. Therefore, the corresponding depressions can likewise be produced on a common plane, i.e. the information density during production can be reduced.

In addition, by the number of at least two latching elements, which form an angle of 180° with respect to each other, it is ensured that mounting is carried out reliably. In so doing, by reason of the two latching elements it is possible to reduce the likelihood of the sprinkler device being introduced into the piping in a skewed manner, i.e. inclined with respect to the axial axis of the sprinkler device. In this way, tilting of the sprinkler device and therefore damage to the sprinkler device or its pipe counter-piece can be avoided.

In particular, damage to the sealing elements can be prevented. Even these sealing elements are to be particularly considered during mounting owing to their function and material properties, which is facilitated by the sprinkler device in accordance with the invention. Owing to the formation of at least two latching elements, reliable function of the sealing elements can thus be ensured.

According to one development of the sprinkler device, the pipe element and the frame element of the sprinkler head can be formed as one piece.

Also, by means of this design, the complexity of the production process and therefore the costs can be reduced. By reducing the number of components, not only is it possible to simplify the production process owing to fewer production steps, the operational reliability of the sprinkler device is also thereby increased. Thus, errors caused by incorrect assembly during the production process are avoided, and also, within the framework of the installation of the sprinkler device, robustness can be increased by the inventive design of the sprinkler device. During installation, there is a force transmission along the sprinkler device, on the one hand along the longitudinal axis and also a torque transmission about the longitudinal axis, such as during turning-in of the sprinkler device. In the case of a multi-part sprinkler device, this force transmission must take place via each interface. In accordance with the invention, damage, for instance as a result of shearing forces or the release of a connection, can be caused particularly at the interfaces.

According to one development of the sprinkler device, a partial region of the outer periphery of the pipe element can be polygonal, preferably hexagonal, in the region of the water outlet opening. This partial region can protrude radially outwards at least partially over the outer periphery of the pipe element.

By means of this development of the sprinkler device, it is also possible to simplify the production process. By means of the polygonal design of the outer periphery which lies in the region of the water outlet opening, and therefore close to an edge region of the pipe element, the clamping-in of the sprinkler device during the production process can be facilitated. In particular, during processing, the pipe element can be held by the formed edges securely and without being damaged. By this means, the process step of rotation in order to form, for instance, a round outer peripheral surface of the pipe element, and of processing the grooves and latching elements is simplified.

The polygonal peripheral region can also serve as an engagement surface for a tool during mounting. If e.g. mounting errors occur, it is possible, by using a conventional tool such as a pipe wrench, to engage the pipe element of the sprinkler device directly. Special tools as frequently used in the prior art are therefore not necessary.

According to one development of the sprinkler device, the at least two latching elements can extend radially outwards from the outer peripheral surface of the pipe element in such a way that an angle is formed between the outer surfaces—which face in the direction towards the water outlet opening—of the at least two latching elements and the outer peripheral surface of the pipe element. This formed angle can be between 30° and 90°, preferably between 45° and 60°.

According to this development, in particular the reliability of the already inserted and turned sprinkler device can be increased. By means of an acute angle between itself and the latching elements producing [the] outer peripheral surface of the pipe element, the position thereof can be defined even more precisely after insertion and turning. In particular, by means of the inherent force of the sprinkler device, i.e. its weight, it is ensured that this lies on the counter-piece of the piping on its downward edges, i.e. those facing in the direction of the weight force. If now these edges are inclined accordingly, radial slipping of the sprinkler device is counteracted.

According to one development of the sprinkler device the sprinkler head can further comprise a deflector which is fastened to the frame element. The liquid-filled glass bulb can lie on the section of the frame element connected to the deflector.

By attachment of a deflector to the sprinkler device in accordance with the invention, the mode of operation thereof is improved by the dispersion of the water over a larger area. By forming the deflector directly on the frame element, further interfaces, such as by additional fastening means, can also be avoided in this case. In addition, it is important for the mode of operation of the deflector for it to be formed in the extension of the middle axis of the pipe element. In this way, it can be ensured that a correspondingly large proportion of the water quantity impacts the deflector and is therefore dispersed. By forming the deflector directly on the frame element, which is connected directly—even as one piece—to the pipe element, this relationship can be ensured in a simple constructive manner.

According to one development of the sprinkler device, the closure element can be formed conically at least in one partial region, widening in the direction towards the water outlet opening. The closure element can thus be displaceably held in guides on the inner periphery of the pipe element in the axial direction of the pipe element in such a way that it closes the water outlet opening. However, when the closure element is not held by the glass bulb, it can move in the guides in such a way that a gap is formed between the closure element and the inner periphery of the pipe element.

This inventive development of the sprinkler device makes the sprinkler device easier to reuse. In the case of a conventional sprinkler, the stopper which closes the water outlet is lost after activation of the sprinkler installation. This is pushed completely out of the water outlet opening if the glass bulb bursts. In contrast, the closure element in accordance with the invention moves only relative to the pipe element and is therefore not lost. By insertion of a new glass bulb, the closure element can again be held in its starting position.

A further advantage of such a design of the closure element is to be found in the fact that the closure element already acts as a deflector. The water exiting the water outlet opening runs over the outer periphery of the closure element. By means of the conical design of the closure element the water is deflected outwards, i.e. radially to the outside of the pipe element and thereby expands the region in which the water is dispersed.

According to a further aspect, a connecting piece is formed. The connecting piece comprises at least two pipe connection openings which are perpendicular to each other in their opening planes. Each pipe connection opening comprises a cylindrically extending body attached as one piece thereto. The connecting piece is characterised in that at least partially circumferential first groove sections which are spaced apart from the first pipe connection opening are formed on an inner peripheral surface of the body of a first pipe connection opening of the at least two pipe connection openings. These first groove sections are connected to first recesses which are preferably radially opposite each other, are spaced apart from each other in the peripheral direction and extend from the first groove sections axially as far as the opening plane of the first pipe connection opening. Furthermore, holding means are formed on an inner peripheral surface of the body at least of a second pipe connection opening of the at least two pipe connection openings.

By means of this connecting piece in accordance with the invention, the sprinkler device call be quickly connected to already existing piping. For this purpose, the connecting piece comprises both a pipe connection opening for attaching the sprinkler device and also a pipe connection opening for attaching the connecting piece itself to existing piping.

Conventional piping systems which may already be used at an installation location of the sprinkler installation can easily be retrofitted by the connecting piece in accordance with the invention. Thus, the connecting piece can be connected by welding or the like to the respective piping by methods known from the prior art, such as by screwing the pipe socket to the piping via corresponding threads which are sealed by means of hemp or Teflon strips.

A plug-and-turn connection similar to the connection between the sprinkler nozzle and connecting piece can likewise be formed between the connecting piece and the respective piping. This type of connection includes further advantages in addition to the time saving during incorporation of the connecting piece on the piping. In this connection, in particular, in addition to the considerably shorter installation time, it is possible to achieve perceptible savings of material, e.g. by the omission of additional sealants such as hemp and the like. In contrast to conventionally known welding processes, this connection is also releasable so that it is also possible in this case to save time and material during maintenance by using a plug-and-turn connection between the connecting piece and piping since a connection cannot be cut open once welded. This also leads to a cost reduction for the sprinkler installation as a whole.

Only one additional element, the connecting piece, is in this case required to attach the sprinkler device. Therefore, the overall costs incurred for use of the sprinkler device can be kept low since both the production costs are limited to the additional connecting piece and furthermore the mounting time is kept short since only one element is required to attach the sprinkler device to piping.

In addition, by such a design for the connecting piece the field of application of the sprinkler device can be increased. Since the connection geometries of the sprinkler device and piping in the case of the connecting piece in accordance with the invention are configured independently of each other, the geometry, i.e. both the type of connection to piping and also the corresponding size ratios are varied while the geometry for connection to the sprinkler device remains the same. The production process can thus remain largely unchanged despite changing boundary conditions.

By the design of first recesses which extend as far as the opening plane of the first pipe connection opening and are connected to circumferential groove sections, the connection which adjoins the first pipe connection opening can be formed by controlling a processing machine along only two mutually perpendicular axes. The production process is therefore kept as simple as possible.

According to one development of the connecting piece, at least partially circumferential second groove sections which are spaced apart from the second pipe connection opening can be formed as holding means of the at least one second pipe connection opening. These second groove sections are connected to second recesses which are preferably radially opposite each other, are spaced apart from each other in the peripheral direction and extend from the second groove sections axially as far as the opening plane of the second pipe connection opening.

By the design of a plug-and-turn connection in accordance with the invention, the mounting time can be further reduced not only between the sprinkler device and connecting piece but also between the connecting piece and piping. If pipe clip-like connecting elements, which must be attached to the pipe by means of additional tools, are frequently used in the prior art, in this case the connecting piece can be placed directly over correspondingly designed pipe openings and turned. During this procedure it is also feasible to attach the sprinkler device in the connecting piece even before same is attached to the piping. In this way, the mounting time between the connecting piece and piping can be disassociated from the mounting time between the connecting piece and sprinkler device. For example, the sprinkler device can already be attached in the connecting before the later mounting location of the sprinkler installation.

In addition, the connecting piece in accordance with the invention means that no further tools are required during mounting. Thus, it is possible both to attach the sprinkler device to the connecting piece manually by means of the plug-and-turn connection and also to fasten the connecting piece itself to the piping manually by means of the plug-and-turn connection.

According to a further aspect of the connecting piece, a fastening section designed as an inner thread can be formed as a holding means of the at least one second pipe connection opening.

According to this inventive development of the connecting piece, the field of application of the connecting piece and therefore of the sprinkler device is extended. By means of the inner thread formed on the inner periphery of the fastening section adjoining the second pipe connection opening, the connecting piece can easily be screwed to already existing piping.

A sprinkler system is designed according to a further aspect of the invention. The sprinkler system comprises the above-discussed sprinkler device and the above-discussed connecting piece. The latching elements of the sprinkler device can be introduced into the first groove sections of the connecting piece via the first recesses of the first pipe connection opening in such a way that at least one partial region of the pipe element of the sprinkler head can be inserted into the connecting piece and then, in order to fasten the sprinkler head to the connecting piece, can be rotated relative thereto. In addition, by means of the holding means formed on the connecting piece, a pipe piece can be attached to the connecting piece.

By means of the inventive design of the sprinkler device and of the connecting piece, a system can be formed which greatly shortens the mounting time when installing a sprinkler installation. By means of the large number of sprinkler nozzles which are to be installed e.g. in warehouses, a significant saving in the overall installation time is possible by shortening this action which must be carried out numerous times. In addition, the mounting is possible without further tools, whereby the weight to be held overhead by the fitter is limited to the connecting piece or sprinkler device. Errors are reduced because the fitter's tasks are made easier, whereby the reliability of the sprinkler installation can be increased.

According to one development of the sprinkler system, a bore can be formed in a partial region of a wall of the body at least of one of the at least two pipe connection openings. This bore can preferably extend through at least one of the groove sections, radially through the partial region of the wall of the body and at least partially outwards. A securing element formed separately or formed on the sprinkler device or the pipe piece can extend in this bore.

By means of the bores in accordance with the invention on the connecting piece, both a means of securing the sprinkler device on the connecting piece and also a means of securing the piping on the connecting piece can be produced. The working steps of the production process required for securing purposes are thereby limited only to the production of the connecting piece. The production time for the sprinkler device thus remains unaffected.

The securing element can additionally not only prevent turning of the elements with respect to each other but, by means of the securing element the achievement of a specific position can additionally be detected. For instance, screwing-in of the securing element is possible when the connecting piece is in only one specific position in relation to the sprinkler device. In this way, the mounting can be facilitated since by means of the securing element it is possible to check that fastening has been carried out as specified. Therefore, the reliability of the whole sprinkler installation can be increased.

Further aspects of the invention relate to a method for producing a sprinkler device according to claim 13, a method for producing a connecting piece according to claim 17 and the use of the sprinkler device in accordance with the invention and of the connecting piece in accordance with the invention to form a sprinkler system according to claim 21. In this respect, the above-discussed effects and advantages will similarly become clear.

### BRIEF DESCRIPTION OF THE DRAWING

The features and advantages as well as the technical and economic significance of exemplified embodiments of the present invention are described hereinunder with reference to the attached drawings in which:

FIG. 1 shows a perspective schematic view of an embodiment of a sprinkler device in accordance with the invention;

FIG. 2 shows a perspective schematic view of an embodiment of a sprinkler device in accordance with the invention from the direction of the frame element;

FIG. 3 shows a perspective schematic view of an embodiment of a connecting piece in accordance with the invention;

FIG. 4 shows a perspective schematic view of a further embodiment of a connecting piece in accordance with the invention;

FIG. 5 shows a perspective view of a sprinkler system which is attached to a pipe piece; and

FIG. 6 shows a perspective schematic view of a piping system.

### DETAILED DESCRIPTION OF EMBODIMENTS

Embodiments of the invention are described in detail hereinunder with reference to the attached drawings.

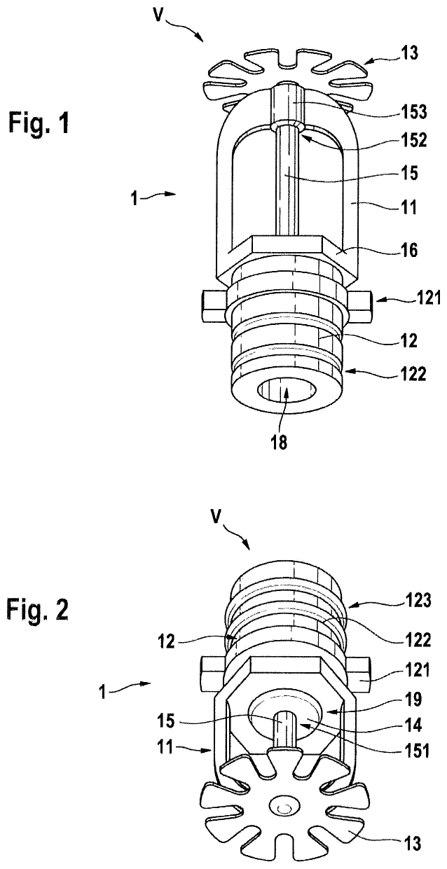

FIG. 1 shows an embodiment of a sprinkler device V in accordance with the invention, consisting of a sprinkler head 1 which comprises a pipe element 12 and a frame element 11 integerally connected as one piece to this pipe element 12. The pipe element 12 is in this case a pipe piece with a through-opening which extends through the whole pipe element 12 in the axial direction. An opening—shown at the bottom in FIG. 1—of the pipe element 12 is the water inlet opening 18. Via the water inlet opening 18, the water supplied in a piping system connected to the sprinkler head 1 reaches the pipe element 12 of the sprinkler device V.

The opening opposite the water inlet opening 18 in the axial direction of the pipe element 12 is formed as a water outlet opening 19. Through this water outlet opening 19 the water from the piping system can be discharged via the water inlet opening 18 out of the pipe element 12.

A frame element 11 adjoins the side of the water outlet opening 19 of the pipe element 12. The frame element 11 is attached to two sections of the pipe element 12 which lie oppositely in the radial direction. Starting from these two sections, the frame element 11 extends via at least two limbs in the axial direction of the pipe element 12 further in the upwards direction, i.e. away from the pipe element 12. The upper end of the frame element 11 is characterised by a connecting region 153 in which the limbs extending on both sides come together.

This region, i.e. the connecting region 153 of the limbs extending symmetrically on both sides, lies opposite the water outlet opening 19 in the extended middle axis of the pipe element 12. A through-bore is formed in the connecting region 153 of the frame element 11. The axis of this through-bore also extends along the extended middle axis of the pipe element 12. By means of this through-bore a glass bulb 15 can be fastened to the frame element 11, the operation of said bulb being described hereinunder. In the embodiment illustrated herein, the frame element 11 and the pipe element 12 are formed as one piece. The material of these elements is to be selected to be both temperature-resistant and also pressure-resistant.

In this embodiment, the frame element 11 and the pipe element 12 are formed from brass but can also be produced e.g. from stainless steel, aluminium or another corrosion-resistant metal. In the embodiment illustrated herein, two grooves 122 extending on the outer periphery in the peripheral direction are formed on the pipe element 12. The number of grooves 122 formed on the outer periphery can vary. For example, only one groove 122 can be formed or e.g. three grooves 122 can also be formed. Furthermore, latching elements 121 are formed on the outer periphery of the pipe element 12.

In the embodiment illustrated herein, the latching elements 121 are designed as cuboidal pieces which extend radially outwards in relation to the middle axis of the pipe element 12 and away from the outer periphery of the pipe element 12. The latching elements 121 are in this case formed as one piece with the pipe element 12 but can also be attached thereto retrospectively. For example, the latching elements 121 can be screwed into the pipe element 12 via bores. Whitworth threads and corresponding fittings can be used. In addition, sealing elements such as a sealing strip or hemp can also be provided. Similarly, the latching elements 121 can be stuck or welded to the pipe element 12.

The latching elements 121 can be formed from the same material as the pipe element 12 but also from a different material. The cross-sectional surface of the latching elements 121, which extends perpendicularly to the axial direction of the pipe element 12, can, in addition to the rectangular shape as in the example of the cuboidal piece, also be square, circular or polygonal. For example, the latching elements 121 can be formed as hemispheres or pins.

The latching elements 121 are in this case disposed on a common plane perpendicular to the axial direction of the pipe element 12 but can also be disposed on mutually parallel offset planes. The latching elements 121 illustrated in FIG. 1 have the same geometry in this embodiment. However, the design of the latching elements 121 is not limited to this identical structure. Thus, different latching elements 121 can be formed in such a way that insertion of the sprinkler head 1 into a connecting piece 2, as described below, can take place only when these elements are in one position relative to each other.

In contrast to the sprinkler nozzles described in the prior art, the sprinkler device V in accordance with the invention can be attached by means of these latching elements 121 to a corresponding counter-piece, the connecting piece 2. For this purpose the sprinkler head 1 is inserted with its pipe element 12 foremost into the connecting piece 2, being guided by means of the latching elements 121, and is then turned. The movement to be carried out by the fitter can thus be reduced to a plug-and-turn movement, wherein the rotational movement is limited to a rotation of less than 180° depending on the number of latching elements 121 and the number of complementary recesses in a connecting piece 2 to be described hereinunder. The fitter can mount the sprinkler device V by a quick movement without gripping around it, as is not possible in the prior art owing to the multiple screw threads to be screwed in.

The latching elements 121 can have mutually different shapes in order to achieve a specific relative position between the sprinkler device V and connecting piece 2 in such a way that in each case a latching element 121 fits in only one complementary recess 212a on the connecting piece 2 described hereinunder. For example, a latching element 121 can be formed with a triangular cross-section and a second latching element 121 can be formed with a rectangular cross-section. In the example illustrated herein, two latching elements 121 are formed, in an opposing arrangement in relation to the axial direction of the pipe element 12. However, a number of latching elements 121 can also be formed approximately at the same angular spacing from each other on the outer periphery of the pipe element 12.

In order to apply a uniform distribution of force onto the sprinkler head 1 during mounting, it is preferable for the latching elements 121 to be formed at the same angular spacing with respect to each other. However, this angular spacing can also be varied. An upper partial region 16 of the pipe element 12, i.e. an edge region which, in relation to the spacing in the axial direction of the pipe element 12, is further away from the water inlet opening 18 than the grooves 122 and the latching elements 121, is formed as a polygon on its outer periphery. In other words, this partial region 16 formed as a hexagon in this embodiment therefore forms the edge region of the pipe element 12 at which the frame element 11 is connected to the pipe element 12.

As described above, different metals such as brass, iron, aluminium or alloys can be used as the basic material of the sprinkler device V, i.e. as the material for the frame element 11 and pipe element 12. The basic shape of the sprinkler device V, which is composed of the frame element 11, the polygonal partial region 16 of the pipe element 12, the pipe element 12 itself and latching elements 121 formed thereon, can be produced by deformation such as forging. Alternatively, this basic shape can be achieved by moulding such as casting. Partial regions such as the frame element 11 and the pipe element 12 can also be produced separately as cast or forged parts and then welded. It is also feasible to produce such geometric shapes by 3D printing such as selective laser melting or electron beam melting.

As a further alternative a basic body without a cavity can be produced by means of casting or forging. From this solid material, the pipe element 12 and/or the frame element 11 can then be formed by machining. In so doing, e.g. by boring and subsequent turning or milling of the inner surface, e.g. by means of side milling cutters, the inner periphery of the pipe element 12 is produced as a tubular section penetrating through along the middle axis.

Subsequently, at the same time as, or prior to, this working step, the outer surface of the pipe element can likewise be processed by turning. If, in the basic shape of the sprinkler head 1 of the sprinkler device V, the latching elements 121 have not yet been formed for instance by a corresponding negative mould, e.g. a strip mould, during casting, this processing is carried out within the scope of the processing of the outer surface of the pipe element 12. Similarly, in this case the at least one groove 122 is removed by a cutting process as a peripheral depression on the outer periphery of the pipe element 12.

This at least one groove 122 is, in the axial direction, spaced further from the frame element 11 or the water outlet opening 19 than the latching elements 121. The surface properties of the individual sections can vary. Thus, e.g., only processing of the surface of the pipe element 12 starting from the water inlet opening 18 up to and including the at least one groove 122 can take place so that the sealing element 123 is not damaged during placement by the surface being too rough. The surface of the further sections of the sprinkler head 1 can remain unprocessed. Alternatively, further regions can be processed, such as the side surfaces of the latching element 121, which point towards both sides in the axial direction of the pipe element 12, in other words, are perpendicular thereto.

In particular, the surface of the side surfaces of the latching elements 121 can be processed in such a way that the frictional resistance arising as the sprinkler head 1 is being turned into the connecting piece 2 is as low as possible. As described above, one side of the glass bulb 15 is fastened to the frame element 11. The second, opposing side of the glass bulb 15 is held by means of a closure element 14. This closure element 14 is inserted as a stopper into the inner periphery of the pipe element 12 at the water outlet opening 19. The closure element 14, when held in its position via the glass bulb 15, thereby closes the water outlet opening 19.

The surface of the inner periphery of the pipe element 12 can be processed to receive the closure element 14 in such a way that e.g. a pressing connection can be produced between the closure element 14 introduced into the pipe element 12 and the inner periphery of the pipe element 12. The closure element 14 and the deflector 13, which is then attached to the frame element 11, e.g. by means of a screw connection, welded connection or adhesive connection, can be produced from the same material as the basic body of the sprinkler head 1 but can also consist of a different material.

FIG. 2 shows a sprinkler head 1 according to the invention from the direction of the frame element 11. As shown in this figure, two sealing elements 123 are introduced into the grooves 122 on the pipe element 12. However, the number of sealing elements 123 is not limited and can vary according to the number of grooves 122. By means of these sealing elements 123, the gap produced between the outer periphery of the pipe element 12 of the sprinkler device V and an inner periphery of the connecting piece 2 will be sealed in such a way that water under high pressure in the piping cannot escape through this gap. In this embodiment, O-rings are formed as sealing elements 123, it being possible to produce the O-rings from rubber. Alternatively, instead of O-rings, other sealing elements such as X-rings or cord rings can also be formed.

Furthermore, as shown in FIG. 2, the water outlet opening 19 is closed by a closure element 14. The closure element 14 is held in the water outlet opening 19 via a first end 151 of the glass bulb 15. As described above, the second end 152 of the glass bulb 15 is held at the intersection 153 of the limbs of the frame element 11. The glass bulb 15 serving as a closure is filled with a special coloured liquid which for its part contains an air bubble. As mentioned above, a plurality of sprinkler heads 1 are attached to the ceiling or in the upper region of side walls where the sprinkler installation V is mounted, said sprinkler heads being connected to a water pipe network.

A constant water pressure which is controlled in the sprinkler control centre prevails within the sprinkler system S. In the event of a fire, the liquid in the glass bulbs 15 located in the vicinity heats up and expands owing to the rising temperature until the glass bulbs 15 burst, whereby the water outlet openings 19 are opened and water exits the sprinkler pipe network. However, in the event of a fire only the water outlet openings 19 of the sprinkler installation V where the glass bulbs 15 have reached the activation temperature open.

In this connection, depending on the area of use of the sprinkler installation, another previously defined temperature can lead to shattering of the glass bulb 15. The activation temperature depends on the size of the enclosed air bubble and is generally indicated by the colour of the liquid in the glass bulb 15. On average, the activation temperature is about 30° C. above the expected ambient temperature. After the glass bulb 15 has shattered, the closure element 14 is no longer held by the glass bulb 15 in the water outlet opening 19 and falls out under its own weight or is pressed out of the pipe element 12 by the water pressure prevailing in the piping system.

Water can now be let out into the surrounding area through the water outlet opening 19 which is now no longer closed. A deflector 13 can also be formed in the axial direction of the pipe element 12 on the side of the frame element 11 opposite the water outlet opening 19. This deflector can be attached directly to the frame element 11 or via a connecting element such as a screw, rivet or adhesive connection thereon. If the water now exiting the water outlet opening 19 hits the deflector 13, it is dispersed thereon over a larger area depending on the geometry of the deflector 13. In this connection, it is preferred that the deflector 13 has a peripheral surface which is as large as possible and is e.g. comb-shaped so that water flowing past is distributed over a large area.

In another embodiment, the closure element 14 is held in the pipe element 12 in an axially displaceable manner and is conical in this embodiment. In order to allow axial displacement of the closure element 14, guide grooves are formed e.g. on the inner periphery of the pipe element 12. Guide teeth corresponding to these guide grooves can be formed on the conical closure element 14. These guide teeth can be biased by springs which are formed e.g. in bores in the closure element 14.

Upon axial displacement of the closure element 14, e.g. directly after shattering of the glass bulb 15, these guide teeth move outwards in the peripheral direction owing to the spring force so that the guide teeth are held in the guide grooves and the closure element 14 can be displaced downwards in a guided manner. In other words, after shattering of the glass bulb 15, the closure element 14 is displaced downwards by the pressure prevailing in the piping system. The guide grooves extend axially in only a partial region of the inner periphery of the pipe element 12 so that the closure element 14 cannot fall out of the pipe element 12 but is limited in its movement by an axial limit of the guide grooves.

In this embodiment, if the glass bulb 15 bursts as described above, the closure element 14 is pressed downwards, whereby, owing to the conical shape of the closure element 14, an annular cavity is formed between the inner periphery of the pipe element 12 and the outer periphery of the closure element 14. The water can be let out of the water outlet opening 19 only through this cavity and be dispersed owing to the conical shape of the closure element 14. The shape of the closure element 14 thus determines the flow direction and spreading diffusion and can therefore likewise have a comb-like contour or the like on the lower outer periphery.

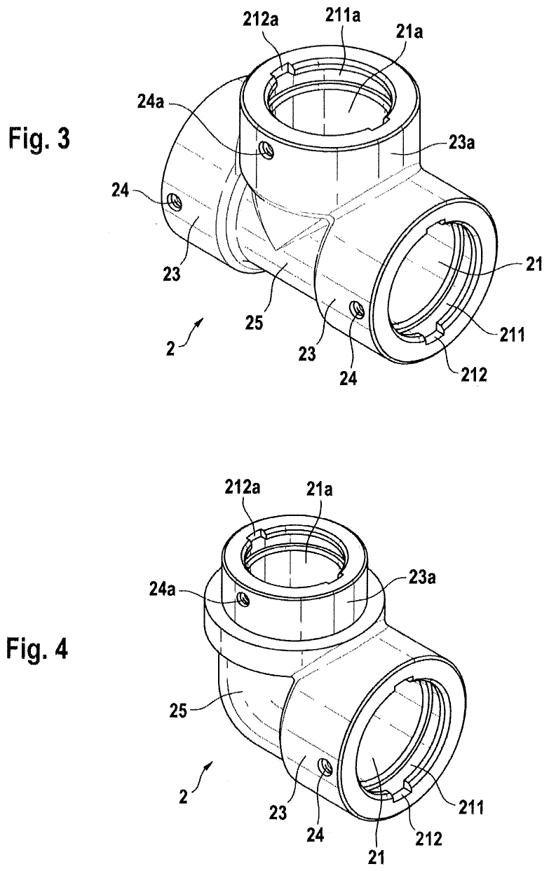

FIG. 3 shows an embodiment of a connecting piece 2 in accordance with the invention. The connecting piece 2 illustrated here has three pipe connection openings 21, 21a. The opposing pipe connection openings 21 are formed for connection to a pipe piece R of a piping system, while the pipe connection opening 21a perpendicular to the two pipe connection openings 21 is formed for connection of the connecting piece 2 to the sprinkler head 1 of the sprinkler device V. For this purpose, recesses 212a are formed on an inner periphery of the connecting piece 2 corresponding the latching elements 121.

The connecting piece 2 has bodies 23, 23a adjoining the respective pipe connection opening 21, 21a. In the embodiment illustrated here, the bodies 23, 23a are each formed as one piece as part of the connecting piece 2. Thus, the basic body of the connecting piece 2 can be produced by moulding, e.g. casting, or by means of deformation, e.g. forging. Starting from this connecting piece basic body, the cylindrical hollow sections of the subsequent connecting piece 2 can be formed starting from the end regions by means of processing by turning or milling. Alternatively, it is also feasible to produce such geometric shapes by 3D printing such as selective laser melting or electron beam melting.

The cylindrical hollow sections are connected to each other in such a way that the subsequent connecting piece 2 has a single cavity, i.e. one going through to each of the pipe connection openings 21, 21a which will be formed later. Alternatively, the cavities can already be formed in the connecting piece basic body by corresponding cores in the case of casting or forging dies in the case of forging so that only the surfaces must be processed in order to form the cylindrical hollow sections. The end sections are then processed. The corresponding end sections are processed according to the design of the connecting piece 2 as a T-piece or angle piece or the like.

The pipe connection opening 21a for connection to the sprinkler device V is formed on one end section, while the pipe connection opening 21 for connection to a pipe piece R of a piping system is formed on the at least one second end section. Starting from the plane of the pipe connection opening 21a on the body 23a, the recesses 212a are milled as depressions extending perpendicularly to the axis of the pipe element 12 and formed towards the inside parallel to the axis. Hereinunder, a groove section 211a is formed at each recess 212a.

The sequence of the production process can be varied in such a way that first a groove section 211a and then the corresponding recess 212a is formed. The groove sections 211a can be processed e.g. by means of side milling cutters. According to the type of connection between the pipe piece R and connecting piece 2, the inner surface of the at least one body 23 can be processed corresponding to the processing of the body 23a in order to form groove sections 211 and recesses 212. Alternatively, a thread can be formed on the inner surface of the body 23 by a thread cutter. Finally, machining steps can be carried out in order to reduce the surface roughness. Furthermore, method steps which change the surface properties, such as coating, can also be carried out on the connecting piece 2 and the sprinkler head 1.

In particular, the inner peripheral surface of the body 23a can be processed so that the surface quality is such that the sealing elements 123 are not damaged when the pipe element 12 is introduced. Bores 24, 24a in which inner threads are formed can also be introduced perpendicularly to the axis of the bodies 23, 23a. These bores 24, 24a can be formed e.g. at a point on the body 23a so that they terminate in the groove sections 211a on the inner periphery of the body 23a. For example, the bores 24a can terminate at a position in the groove sections 211a so that, when the sprinkler head 1 is inserted, a screw introduced through the bore 24a lies between the latching element 121 and associated recess 212a.

In this embodiment, unscrewing the sprinkler device V from the connecting piece 2 can be effected only after the screw has been correspondingly unscrewed from the bores 24a. The screw inserted through the bores 24, 24a therefore serves to determine and secure positioning. A correspondingly complementary geometry on the outer periphery of the sprinkler head 1, or of the pipe piece R, approximately in the form of a further bore with an inner thread or simple depression can lie opposite the bore 24, 24a in the correctly inserted state so that the screw can be screwed in only in this correctly inserted state.

The bores 24a can also be formed in the body 23a in such a way that, starting from the inner periphery of the body 23a, they extend radially outwards only over a partial region of the wall thickness of the body 23a. A pin biased via a spring can be inserted in this bore 24a and can latch into a corresponding bore in the sprinkler head 1.

The edges of the connecting piece 2 and the sprinkler device V can be appropriately deburred. Similarly, to the sprinkler device V, however, the connecting piece 2 does not have to be formed as one piece but can be composed of individual single parts, which are screwed or welded to each other, in order to form the connecting piece basic body. In this embodiment, the connecting piece 2 is produced from stainless steel but can also consist of other corrosion-resistant metals, e.g. from brass or aluminium or an alloy. The pipe openings 21, 21a extend into the inside of the connecting piece 2 so that the connecting piece 2 of this embodiment has an approximately T-shaped cavity.

Recesses 212a and groove sections 211a are incorporated on the inner periphery of the body 23a extending from the pipe connection opening 21a. The recesses 212a are formed corresponding to the geometry of the latching elements 121 of the sprinkler head 1. The recesses 212a extend parallel to the middle axis of the body 23a starting from the plane of the pipe connection opening 21a into the inside of the connecting piece 2. The direction in which the recesses 212a extend does not have to be parallel to the middle axis of the body 23a but can also be inclined with respect thereto.

The recesses 212a are a depression in the inner diameter of the body 21a which have e.g. a rectangular cross-section. The recesses 212a further extend in such a way that they open into the groove sections 211a. These groove sections 211a are also depressions in the inner diameter of the body 23a. In contrast to the recesses 212a, the groove sections 211a extend in the peripheral direction of the body 23a and therefore on a plane perpendicular to the direction in which the recesses 212a extend.

The depth of the recesses 212a and of the groove sections 211a, i.e. the radial distance between the inner periphery of the body 23a in a region surrounding the groove sections 211a and recesses 212a, and the inner periphery of the body 23a on which the groove sections 211a or the recesses 212a are formed can be identical. However, the depth of the recesses 2112a and of the groove sections 211a can also differ from each other. Thus, the depth of the recesses 212a can be greater than that of the groove sections 211a. The direction of extension of the groove sections 211a is also not limited to the peripheral direction but can extend e.g. inclined with respect thereto and in an undulating manner or as an L-shape.

The edge of the groove sections 211a which lies furthest away from the plane of the pipe connection opening 21a thus serves as a stop edge for the latching elements 121 of the sprinkler device V. In the embodiment of the connecting piece 2 illustrated in FIG. 3, recesses 212, which extend from the plane of the pipe connection openings 21 towards the inside of the connecting piece 2, and groove sections 211, which extend in the peripheral direction of the inner periphery of the bodies 23, are likewise formed similarly to the recesses 212a and the groove sections 211a. The dimensions of the groove sections 211 and recesses 212 can correspond to those of the groove 211a and of the recess 212a for receiving the sprinkler device V, but can also be different therefrom.

There can be two groove sections 211 or recesses 212 formed on the bodies 23, as illustrated in FIG. 3, but several groove sections 211 and recesses 212 can also be formed. These depressions permit a connection between the connecting piece 2 and the pipe piece R by means of a plug-and-turn connection, similar to the connection between the connecting piece 2 and sprinkler device V. In another embodiment, instead of the groove sections 211 and recesses 212, threaded sections extending from the plane of the pipe connection opening 21 towards the inside of the connecting piece 2 are formed. By means of these inner threads, the connecting piece 2 can be screwed onto a pipe piece R. Alternatively, this connection between the connecting piece 2 and pipe piece R can also be made by welding, pressing or the like.

As also illustrated in FIG. 3, bores are formed in the bodies 23, 23a and extend radially over the wall of the respective body. As illustrated therein, the bores 23, 23a can be formed in each body. Alternatively, only the body 223a in which the sprinkler device 1 is inserted may have bores 24a. The number of bores 24, 24a formed on a body 23, 23a can also vary. Thus, perhaps two radially opposing bores 24a can be formed in the body 23a. For example, screws can be screwed in through these bores 24, 24a.

After being screwed in, the screws abut against the outer periphery of the respectively inserted element, whereby turning of the respectively inserted element, more precisely the piping R or the sprinkler device V, relative to the connecting piece 2 is prevented. In other words, the screws inserted into the bores 24, 24a counteract a certain force which occurs e.g. as a turning moment on the inserted element. Depending on the surface properties of the screw and the point at which the screw meets the inserted element, an adhesive force or—in the case of a relative movement—a frictional force, for instance between the screw and the sprinkler head 1 or the pipe piece R, acts against a possible turning moment.

The adhesive or frictional force is then transferred via the screw to the connecting piece 2. This measure makes it possible to prevent turning and thus loosening of the inserted element and thereby to increase the reliability of the sprinkler installation. The screws can be formed e.g. as set screws. Alternatively, a pin or bolt can also be inserted into the bore. In addition, the screw can have e.g. a screw head which can be counter-sunk into the bores 24, 24a, e.g. as a counter-sunk screw of a correspondingly conical shape.

FIG. 4 shows a further embodiment of a connecting piece 2 in accordance with the invention. As illustrated therein, two pipe connection openings 21, 21a, which are perpendicular to each other in terms of their opening planes, are formed on the connecting piece 2 so that this embodiment forms an angle piece or end piece of the connecting piece 2. A pipe connection opening 21a to receive the sprinkler device V is thus formed, while the second pipe connection opening 21 is formed to receive the pipe piece R. Also, in this embodiment, only the connection between the sprinkler device V and connecting piece 2 is formed by means of corresponding recesses 211a and groove sections 211a as a turn-and-plug connection.

However, this type of connection between the pipe piece R and connecting piece 2 is not specified and can likewise be formed by means of a turn-and-plug connection, illustrated here, using the recesses 212 and groove sections 211. Alternatively, also in this embodiment, an inner thread can be formed on the inner periphery of the body 23, into which thread a pipe piece R can be screwed. As further embodiments of the connecting piece 2, cross pieces or star pieces can also be formed which, in addition to each comprising a pipe connection opening 21a, comprise a plurality, e.g. three or four, of pipe connection openings 21.

As illustrated in FIG. 3 or 4, chamfers can be provided on the peripheral edges of the connecting piece 2 in order to facilitate e.g. the handling of the connecting piece 2. Similarly, the section of the body 23, 23a can have a smaller outer periphery compared with a middle region 25 of the connecting piece 2, i.e. the region which adjoins the body 23, 23a and extends in the direction away from the respective pipe connection openings 21, 21a. In other words, the wall thickness of the connecting piece 2 in the area of the middle region 25 can be smaller than the wall thickness of the bodies 23, 23a. The wall thickness of the middle region 25 can also differ from those of the bodies 23, 23a, wherein the inner periphery between the body 23 and 23a can also vary. Alternatively, the outer periphery between the middle region and the body 23, 23a can be identical, i.e. cannot form any edge.

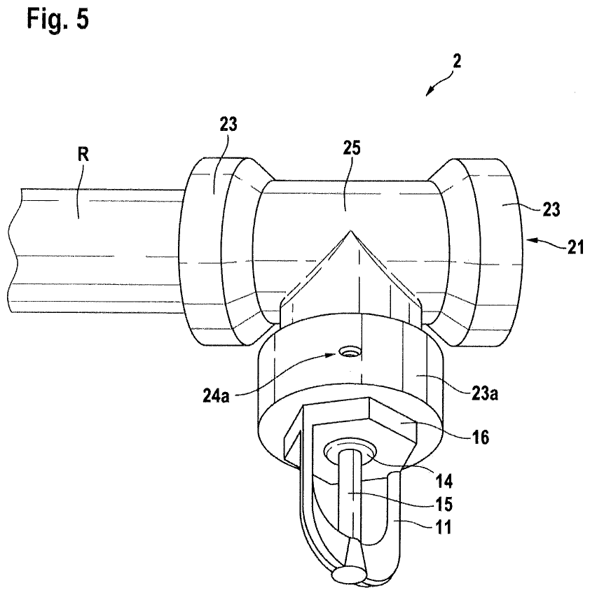

Furthermore, the outer periphery of the body 23 can be identical to the outer periphery of the body 23a but can also deviate therefrom corresponding to the inner periphery. In the case of a plurality of pipe connection openings 21, each body 23 can also have a different outer periphery and inner periphery. FIG. 5 shows an assembled state consisting of the connecting piece 2 and the sprinkler device V, and therefore an embodiment of the sprinkler system S. In this case, a pipe piece R is also inserted into the connecting piece 2 on this sprinkler system S.

More precisely, the pipe piece R is inserted into the body 23 by way of the pipe connection opening 21. By way of the pipe connection opening 21a, the sprinkler device V is inserted in such a way that at least a partial region of the pipe element 12 is located within the body 23a. As shown in FIG. 5, the hexagonal partial region 16 of the pipe element 12 protrudes out of the connecting piece 2 so that the sprinkler device V can easily be reached with a tool via this partial region 16. If, for instance, the sprinkler device V in the pipe piece R tilts during mounting, the fitter can helpfully take a tool and engage it at this location, the partial region 16, without damaging the sprinkler device V. The partial region of the pipe element 12 on which the at least one sealing element 123 and the at least two latching elements 121 are located is received in the connecting piece 2 in the state illustrated in FIG. 3.

Thus the at least one sealing element 123 is in peripheral contact with the inner periphery of the body 23a, while the latching elements 121 are received in the groove sections 211a. In order to achieve this state, the sprinkler device V is inserted with its pipe element 12 in the axial direction or along the middle axis of the body 23a into the connecting piece 2. The edge of the latching elements 121 at the front in the insertion direction then abuts against a boundary surface of the groove sections 211a. From this point in time, in this embodiment, there is no axial movement but only a rotational movement of the sprinkler device V by means of which the latching elements 121 are guided in the groove sections 211a in the peripheral direction.

This rotational movement is also stopped by a boundary surface of the groove sections 211a. The boundary surface of the groove sections 211a can extend in the radial direction, i.e. be perpendicular to a tangent on the inner periphery of the body 23a. Similarly, a boundary surface is possible which forms an acute angle with the tangent of the inner periphery so that the boundary surface runs out. In other words, a boundary surface is feasible which comprises a smaller radius than the inner periphery of the pipe element 12 itself. By means of this initial axial plugging movement and subsequent radial turning movement, the sprinkler device V can be rapidly inserted into the connecting piece 2.

In a similar manner, such a plug-and-turn connection to the pipe piece R can be effected by means of groove sections 211 and recesses 212 of the connecting piece 2. Alternatively, the connection between the pipe piece R and connecting piece 2 can also be formed in a non-releasable manner. Thus, the connection can be formed e.g. by means of welding or pressing. As shown in FIG. 5, the bore 24a extends through the body 23a in a region of the body 23a in which the pipe element 12 of the sprinkler device V is received.

In other words, the screw introduced into the bore 24a abuts against the outer periphery of the pipe element 12 of the sprinkler device V. In addition to securing against turning, the screw can also be used to determine positioning. For example, a dimple can be formed on the outer periphery of the pipe element 12 at a specific point opposite the bore 24a in the assembled state. If, in the sprinkler system S, the screw is screwed into the bore 24a of the pipe element 12 via the bore 24a through the body 23a, it is possible to check thereby that the sprinkler device V is inserted correctly.

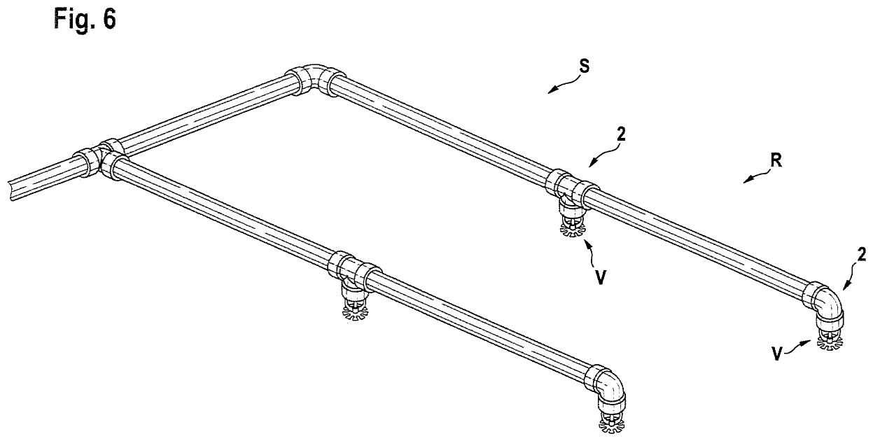

For this purpose, externally visible markings can be provided on the screw and can be used to see how far the screw is screwed in. Thus, by means of a visual check it is possible to quickly detect whether the plug-and-turn connection has been made correctly. FIG. 6 illustrates a piping system. As can be seen therein, between the pipe pieces R, connecting pieces 2 are inserted as T-pieces and, at the respective end sections of the piping system, connecting pieces 2 formed as angle-pieces are connected to only one pipe piece R in each case. In this case, a sprinkler device V is inserted in each case into the connecting pieces 2.

Depending on the field of application of the sprinkler installation, e.g. a specific class of fire risk, different pressure-throughflow rate conditions must be fulfilled. Depending on the field of application, both the inner diameter of the respective pipe pieces R, connecting pieces 2 and of the pipe element 12 of the sprinkler head 1 can be varied. The loading limit can also be varied by means of material properties and wall thicknesses of the named constituent elements. For example, the latching elements 121 can be sized smaller in their dimensions in the case of pressures up to 16 bar than latching elements 121 which are provided in sprinkler devices V which are designed for pressures over 16 bar.

When the sprinkler installation comes into use, i.e. in the event of a fire, the glass bulb 15 shatters in response to a certain temperature. The closure element 14 is pressed out of the water outlet opening 19 and water can be let out via the pipe piece R, the connecting piece 2 and the pipe element 12. This sudden drop in pressure in the piping system can be detected as a signal, whereupon a pump is then operated which supplies sufficient water to the piping system.

A sprinkler device V with a sprinkler head 1 which comprises a pipe element 12 and a frame element 11 connected to the pipe element 12 is proposed. The pipe element 12 comprises at least two latching elements 121 on its outer periphery, which extend radially outwards from the outer peripheral surface of the pipe element 12. In addition, the pipe element 12 has at least one groove 122 extending in the peripheral direction on its outer surface, in which groove a sealing element 123 can be received. When viewed in the axial direction of the pipe element 12 in the direction towards the water inlet opening 18, the at least one groove 122 is spaced further from the water outlet opening 19 than the at least two latching elements 121. Furthermore, a connecting piece 2, a sprinkler system S and a method for producing and using same are proposed.

1. A sprinkler device (V) with a sprinkler head (1) which comprises a pipe element (12) and a frame element (11) connected to the pipe element (12), wherein the pipe element (12) comprises a water inlet opening (18) and a water outlet opening (19) opposite the water inlet opening (18) in the axial direction of the pipe element (12) and facing the frame element (19);
a closure element (14) is received in the water outlet opening (19) and closes same;
between the closure element (14) and the frame element (11), a liquid-filled glass bulb (15) is disposed in the longitudinal direction of the sprinkler head (1) in such a way that its first end (151) lies against the closure element (14) and its second end (152) lies against the frame element (11), whereby the glass bulb (15) holds the closure element (14) in the water outlet opening (19) of the pipe element (12),
characterised in that
the pipe element (12) comprises at least two latching elements (121) on its outer periphery, which extend radially outwards from the outer peripheral surface of the pipe element (12); and
the pipe element (12) further comprises, on its outer surface, at least one groove (122) extending in the peripheral direction, in which a sealing element (123) can be received, wherein, when viewed in the axial direction of the pipe element (12) in the direction towards the water inlet opening (18), the at least one groove (122) is spaced further apart from the water outlet opening (19) than the at least two latching elements (121).

2. Sprinkler device (V) as claimed in claim 1, wherein
the at least two latching elements (121) are disposed on a common plane perpendicular to the axial direction of the pipe element (12).

3. Sprinkler device (V) as claimed in claim 1, wherein
the pipe element (12) and the frame element (11) of the sprinkler head (1) are formed as one piece.

4. Sprinkler device (V) as claimed in claim 1,
wherein
a partial region (16) of the outer periphery of the pipe element (12) is polygonal, preferably hexagonal, in the region of the water outlet opening (19) and protrudes radially outwards at least partially over the outer periphery of the pipe element (12).

5. Sprinkler device (V) as claimed in claim 1, wherein
the at least two latching elements (121) extend radially outwards from the outer peripheral surface of the pipe element (12) in such a way that an angle between 30° and 90°, preferably between 45° and 60°, is formed between the outer surfaces (121a)—which face in the direction towards the water outlet opening (19)—of the at least two latching elements (121) and the outer peripheral surface of the pipe element (12).

6. Sprinkler device (V) as claimed in claim 1, wherein
the sprinkler head (1) further comprises a deflector (13) which is fastened to the frame element (11), and the liquid-filled glass bulb (15) lies on the section of the frame element (11) connected to the deflector (13).

7. Sprinkler device (V) as claimed in claim 1, wherein the closure element (14) is formed conically at least in one partial region, widening in the direction towards the water outlet opening (19), and is displaceably held in guides on the inner periphery of the pipe element (12) in the axial direction of the pipe element (12) in such a way that the closure element (14)—when it is held by the glass bulb (15)—closes the water outlet opening (19), and that the closure element (14)—when it is not held by the glass bulb (15)—is displaced in the guides in such a way that a gap is formed between the closure element (14) and the inner periphery of the pipe element (12).

8. Connecting piece (2) comprising at least two pipe connection openings (21, 21a) which are perpendicular to each other in their opening planes, wherein each pipe connection opening (21, 21a) comprises a cylindrically extending body (23, 23a) attached as one piece thereto,
characterised in that
at least partially circumferential first groove sections (211a) which are spaced apart from the first pipe connection opening (21a) are formed on an inner peripheral surface of the body (23a) of a first pipe connection opening (21a) of the at least two pipe connection openings (21, 21a), these first groove sections are connected to first recesses (212a) which are preferably radially opposite each other, are spaced apart from each other in the peripheral direction and extend from the first groove sections (211a) axially as far as the opening plane of the first pipe connection opening (21a), and
holding means are formed on an inner peripheral surface of the body (23) at least of a second pipe connection opening (21) of the at least two pipe connection openings (21, 21a).

9. Connecting piece (2) as claimed in claim 8, wherein
at least partially circumferential second groove sections (211) which are spaced apart from the second pipe connection opening (21) are formed as holding means of the at least one second pipe connection opening (21), these second groove sections are connected to second recesses (212) which are preferably radially opposite each other, are spaced apart from each other in the peripheral direction and extend from the second groove sections (211) axially as far as the opening plane of the second pipe connection opening (21).

10. Connecting piece (2) as claimed in claim 8, wherein
a fastening section designed as an inner thread is formed as a holding means of the at least one second pipe connection opening (21).

11. Sprinkler system (2) comprising:
a sprinkler device (V) as claimed in claim 1; and
a connecting piece (2) as claimed in claim 8, wherein
the latching elements (121) of the sprinkler device (V) can be introduced into the first groove sections (211a) of the connecting piece (2) via the first recesses (212a) of the first pipe connection opening (21a) in such a way that at least one partial region of the pipe element (12) of the sprinkler head (1) can be inserted into the connecting piece (2) and then, in order to fasten the sprinkler head (1) to the connecting piece (2), can be rotated relative thereto, and by means of the holding means formed on the connecting piece (2), a pipe piece (R) can be attached to the connecting piece (2).

12. Sprinkler system (S) as claimed in claim 11, wherein
a bore (24) is formed in a partial region of a wall of the body (23) at least of one of the at least two pipe connection openings (21, 21a), this bore preferably extends through at least one of the groove sections (211, 211a), radially through the partial region of the wall of the body (23, 23a) and at least partially outwards in order to receive a securing element formed separately or formed on the sprinkler device (V) or the pipe piece (R).

13. Method for producing a sprinkler device (V) as claimed in claim 1, comprising:
forming a sprinkler device basic body with an upper part which serves as a frame element (11) and comprises a contour body which is hollow as seen in plan view, comprises a circumferential wall and extends perpendicularly in one direction from a middle section of the sprinkler device basic body serving as a preferably polygonal base, and with a lower part which is attached as one piece to the base and extends from the middle section, serving as a base, perpendicularly in the direction opposite to the direction of extension of the upper part, machining the lower part to form a tubular section, which passes through the lower part, in order to form a pipe element (12), with a water inlet opening (18) and a water outlet opening (19) opposite the water inlet opening (18) in the axial direction of the pipe element (12) and facing the frame element (11); and
machining the outer surface of the pipe element (12) in order to form at least two latching elements (121) and at least one groove (122) on the pipe element (12), wherein the latching elements (121) extend radially outwards from the outer peripheral surface of the pipe element (12) and the at least one groove (122), as viewed in the axial direction of the pipe element (12) in the direction towards the water inlet opening (18), is spaced further from the water outlet opening (19) than the at least two latching elements (121).

14. Method for producing a sprinkler device (V) as claimed in claim 13, further comprising:
inserting a closure element (14) into the pipe element (12); and
inserting at least one sealing element (123) into the at least one groove (122).

15. Method for producing a sprinkler device (V) as claimed in claim 14, further comprising:
inserting a liquid-filled glass bulb (15) between the closure element (14) and the frame element (11) in such a way that its first end (151) lies against the closure element (14) and its second end (152) lies against the frame element (11), whereby the glass bulb (15) holds the closure element (14) in the water outlet opening (19) of the pipe element (12).

16. Method for producing a sprinkler device (V) as claimed in claim 14, further comprising:
fastening a deflector (13) to the frame element (11), wherein the liquid-filled glass bulb (15) lies on the section of the frame element (11) connected to the deflector (13).

17. Method for producing a connecting piece (2) as claimed in claim 8, comprising:
forming a connecting piece basic body with at least two mutually perpendicular end regions;
processing the connecting piece basic body in order to form a first cylindrical hollow section and at least one second cylindrical hollow section which is perpendicular to the first cylindrical hollow section, wherein the cylindrical hollow sections are connected to each other in order to form a hollow body;
processing an end section of the first cylindrical hollow section in order to form a first connection part with a first pipe connection opening (21a),
processing an end section of the at least one second cylindrical hollow section in order to form at least one second connection part with at least one second pipe connection opening (21),
wherein opening planes of the pipe connection openings (21, 21a) are perpendicular to each other and each pipe connection opening (21, 21a) comprises a cylindrically extending body (23, 23a) formed as one piece thereon;
processing an inner peripheral surface of the body (23a) of the first pipe connection opening (21a) in order to form at least partially circumferential first groove sections (211a) which are spaced apart from the first pipe connection opening (21a), and first recesses (212a) which extend from the first groove sections (211a) axially as far as the first pipe connection opening (21a) and are formed preferably radially opposite each other; and
processing an inner peripheral surface of the body (23) of the at least one second pipe connection opening (21) in order to form holding means.

18. Method for producing a connecting piece (2) as claimed in claim 17, wherein:
the holding means of the at least one second pipe connection opening (21) are formed as at least partially circumferential second groove sections (211) which are spaced apart from the second pipe connection opening (21), which second groove sections are connected to second recesses (212) which are preferably radially opposite each other, are spaced apart from each other in the peripheral direction and extend from the second groove sections (211) axially as far as the opening plane of the second pipe connection opening (21).

19. Method for producing a connecting piece (2) as claimed in claim 17, wherein:
a fastening section designed as an inner thread is formed as a holding means of the at least one second pipe connection opening (21).

20. Method for producing a connecting piece (2) as claimed in claim 17, further comprising:
forming a bore (24) in a partial region of a wall of the body (23, 23a) at least one of the pipe connection openings (21, 21a) in such a way that the bore (24) extends at least partially outwards preferably through at least one of the groove sections (211, 211a) radially through the partial region of the wall of the body (23, 23a).

21. (canceled)
